(19) United States
(12) Patent Application Publication
(10) Pub. No.: US 2025/0303389 A1
(43) Pub. Date: Oct. 2, 2025

(54) BIOCHAR-COATED PLASTIC

(71) Applicants: Elham Fini, Phoenix, AZ (US); Farideh Pahlavan, Chandler, AZ (US)

(72) Inventors: Elham Fini, Phoenix, AZ (US); Farideh Pahlavan, Chandler, AZ (US)

(21) Appl. No.: 19/092,112

(22) Filed: Mar. 27, 2025

Related U.S. Application Data
(60) Provisional application No. 63/570,359, filed on Mar. 27, 2024.

(51) Int. Cl. B01J 20/20; B01J 20/28; C04B 18/12; C04B 18/20; C04B 20/10; C04B 22/06; C04B 28/00; C04B 103/00; C04B 111/00; C08L 95/00

(52) U.S. Cl. CPC B01J 20/20; B01J 20/28016; B01J 20/28023; C04B 18/12; C04B 18/20; C04B 20/1014; C04B 20/1055; C04B 22/062; C04B 28/006; C08L 95/00; C04B 2103/0078; C04B 2111/00017; C08L 2207/20; C08L 2555/50; C08L 2555/80

(57) ABSTRACT

A building material includes bio-oil treated plastic and biochar adhered to an exterior surface of the bio-oil treated plastic Capturing metals from mine tailings includes combining the building material, mine tailings, and an alkaline activator to yield a mixture, and polymerizing the mixture to yield a geopolymer.

### CROSS-REFERENCE TO RELATED APPLICATION

This application claims the benefit of U.S. Patent Application No. 63/570,359 filed on Mar. 27, 2024, which is incorporated herein by reference in its entirety.

### STATEMENT OF GOVERNMENT SUPPORT

This invention was made with government support under 1935723 awarded by the National Science Foundation. The government has certain rights in the invention.

### TECHNICAL FIELD

This invention relates to biochar-coated plastics for incorporation into building materials and the built environment to facilitate removal or immobilization of contaminants, such as metals and volatile organic compounds.

### BACKGROUND

The use of mine tailings in construction has been explored as a means of resource conservation and waste valorization. For instance, mine tailings such as copper mine tailings have been used in concrete and geopolymers that meet the minimum compression strength required for application in construction.

### SUMMARY

This disclosure describes biochar-coated plastics for removal and immobilization of metal leachates from various compositions (e.g., industrial waste, mine tailings, waste engine oil) used in construction and the built environment. In one example, biochar-coated plastics are incorporated in open-graded friction course pavement to facilitate selective removal of contaminants such as metals and volatile organic compounds from surface run-off and to improve drainage and resistance of roadways to rutting. Thus, biochar-coated plastics allow the combination of plastic waste and biowaste into valuable products that can reduce exposure to contaminants.

In a first general aspect, a building material includes bio-oil treated plastic and biochar adhered to an exterior surface of the bio-oil treated plastic.

Implementations of the first general aspect can include one or more of the following features. In some cases, the bio-oil treated plastic includes waste plastic. The waste plastic includes polyethylene terephthalate, polyethylene terephthalate glycol, or a combination thereof. In certain implementations, the bio-oil treated plastic includes plastic granules or plastic fibers. In one example, the biochar includes algae biochar. In some cases, the biochar has a selectivity order of Cu²⁺>Fe²⁺>Zn²⁺ for biochar adsorption. The K⁺ ions of the biochar can be displaced from a nitrogen site of amines, amides, or any combination thereof. In some cases, an affinity of heavy metal ions in the biochar is greater for nitrogen-containing functional groups than oxygen-containing groups. In one example, the heavy metal ions include Cu²⁺, Fe²⁺, Zn²⁺, or any combination thereof. The building material can further include aggregate. In certain implementations, the building material further includes mine tailings and the mine tailings can include copper mine tailings.

In a second general aspect, a geopolymer material includes the building material of the first general aspect.

In a third general aspect, a cement includes the building material of the first general aspect.

In a fourth general aspect, an asphalt includes the building material of the first general aspect. In some cases, the asphalt is an open-graded friction course asphalt.

In a fifth general aspect, capturing metals from mine tailings includes combining the building material of the first general aspect, mine tailings, and an alkaline activator to yield a mixture, and polymerizing the mixture to yield a geopolymer.

Implementations of the fifth general aspect can include one or more of the following features. In some cases, the mine tailings include copper mine tailings. In one example, the alkaline activator includes sodium hydroxide. In certain implementations, an alkaline environment created by the alkaline activator deprotonates acidic functional groups.

The details of one or more embodiments of the subject matter of this disclosure are set forth in the accompanying drawings and the description. Other features, aspects, and advantages of the subject matter will become apparent from the description, the drawings, and the claims.

### BRIEF DESCRIPTION OF DRAWINGS

FIG. 1 is a schematic representation of algae biochar.

FIG. 2 is an electrostatic potential-colored molecular surface map on a blue-white-red color scale for algae biochar. Red-filled surfaces are electron-depleted regions. Blue-filled surfaces are electron-accumulated regions.

FIG. 3 is a schematic representation of mechanisms involved in adsorption of heavy-metal ions by biochar.

FIG. 4 shows comparisons of density functional theory-based adsorption energy showing the interaction of heavy-metal ions (Cu²⁺, Zn²⁺, and Fe²⁺) with algae biochar through cation-π, complexation, and ion-exchange mechanisms.

FIG. 5 is an ultraviolet-visible spectrum of algae biochar in dichloromethane: ethanol (8:2, v/v) displaying a characteristic absorption band at 275 nm.

FIG. 6 shows ultraviolet-visible absorption spectra of algae biochar in the presence of FeCl₂, CuCl₂ and ZnCl₂ along with metal and biochar controls.

### DETAILED DESCRIPTION

This disclosure describes biochar-coated plastics for incorporation in building materials and the built environment. Biochar is a carbon-rich product obtained from thermal decomposition under low-oxygen conditions of organic material such as algae, plant material (e.g., wood), biowaste, and agricultural waste. Biochar has high porosity and surface area, is chemically stable, and has a molecular structure that is rich in oxygen and nitrogen-containing functional groups. These properties facilitate removal and immobilization of contaminants such as metals and volatile organic compounds from fluids in contact with the biochar-coated plastics. The incorporation of biochar into construction materials such as cement and asphalt facilitates the advantageous use of waste biomass and promotes carbon sequestration and removal of harmful substances from the environment. Moreover, the integration of biochar can enhance the physical properties and durability of construction materials, thereby improving the performance and sustainability of infrastructure.

Biochar-coated plastics are fabricated by coating biochar onto plastic. The plastic can be in a variety of shapes and sizes (e.g., powder, granules, flakes, fibers, etc.). The plastic can be made from waste plastic. Examples of suitable waste plastics include polyethylene terephthalate, polyethylene terephthalate glycol, and combinations thereof. The biochar-coated plastics can be used as a partial replacement for aggregate in construction materials such as asphalt and cement.

Preparing biochar-coated plastics include combining the plastic with plant-based oil (e.g., bio-oil), heating the mixture, removing the excess bio-oil, and drying the plastic to yield treated plastic. The plastic and the plant-based oil are typically combined in a weight ratio of about 2:1 to about 1:2 (e.g., about 1:1)), One example of a suitable bio-oil is waste vegetable oil. Biochar is combined with the treated plastic (e.g., in a weight ratio of 1:2 biochar to treated plastic) in an aqueous solution to yield a mixture. The mixture is agitated and then dried to yield the biochar-coated plastic.

In one example, biochar-coated plastics are used as a partial replacement for aggregate in an open-graded surface mix for open-graded friction course pavement. Open-graded friction course pavement is a permeable layer of asphalt that has a uniform aggregate grading with a low content of fine aggregates. This results in a large number of air voids and, thus, high porosity. Open-graded friction course pavement is typically designed and constructed with 15% to 25% voids by volume, a range that allows surface water to drain through the mix to the edge of pavement. This range of voids reduces the risk of hydroplaning. Incorporation of biochar-coated plastics in an open-graded friction course pavement can enhance performance of the pavement by removing metals (e.g., copper, iron, and zinc), long chain polycyclic aromatic hydrocarbons, and perfluoroalkyl and polyfluoroalkyl substances. Accordingly, incorporation of biochar-coated plastics in an open-graded friction course can amplify the role of the open-graded friction course in removal of contaminants while enhancing road resistance to permanent deformation (e.g., rutting).

In another example, biochar-coated plastics are combined with mine tailings in the construction of roadway base and sub-base to immobilize metals and thus inhibit leaching to surface and ground water. Mine tailings are rich in aluminosilicate content and can be used as additives in cement and asphalt. Mine tailings can also possess high levels of heavy metals and toxic substances. Mine tailings are typically stored in mine-waste dumps and tailings ponds as a slurry, presenting environmental concerns. Combining biochar-coated plastics with mine tailings in construction materials can promote removal and immobilization of metals and volatile organic compounds from the mine tailings, thereby facilitating the use of mine tailings in construction materials.

The use of mine tailings in construction has been explored as a means of resource conservation and waste valorization. However, the leachate of heavy metals from mine tailings is a deterrent to their application in construction. For instance, mine tailings (e.g., copper mine tailings) have been used in concretes and geopolymers that meet the minimum compression strength required for application in construction. However, the metal leachates in mine tailings can compromise the safe use of these materials in construction.

Geopolymerization of mine tailings can decrease the leaching of heavy metals. However, even though the leaching of metals from geopolymers is typically less than that from the original source material, further minimization of leaching would be advantageous. As described herein, one such method includes modifying the mine-tailings-based geopolymer matrix with biochar-coated plastics. The integration of biochar can help encapsulate heavy metals within the geopolymer matrix. This promotes sustainable resource use and optimizes the geopolymer's environmental performance by reducing the mobility of any residual heavy metals and their potential for leaching into the surrounding environment.

Geopolymers can be generated by merging mine tailings with a common alkaline activator, such as sodium hydroxide (NaOH). By incorporating biochar produced from microalgae Cyanidioschyzon merolae [C. merolae] into the mine-tailings-based geopolymers, heavy metals can be effectively trapped within the biochar structure, minimizing their risk of leaching. Factors to be considered include the nature and concentration of the metals present, the properties of the biochar (e.g., its source material, pyrolysis conditions, and functional groups in its structure), the amount of biochar incorporated, and the environmental conditions to which the geopolymer is exposed.

The capacity of algae biochar to selectively adsorb three heavy metals present in copper mine tailings (e.g., copper, iron, and zinc) is described. To understand the role that nitrogen-containing functional groups play in algae biochar's effective adsorption of the selected heavy metals, quantum-based molecular modeling (e.g., density functional theory) is used. The underlying mechanisms driving the removal of these heavy metals by biochar from the environment are elucidated through a series of comprehensive characterizations and analyses, providing detailed insight into the metal-sequestration capabilities of biochar material.

Examining the interactions between algae biochar and the target heavy metals involves creating a molecular model of the biochar surface. This molecular model provides insight into the possible interactions between the algae biochar and heavy metals, thereby shedding light on the selective adsorption process. A molecular model that accurately reflects the elemental composition and functionalities of algae-based biochar includes the primary features of biochar: the carbonaceous skeleton and the surface functional groups. Graphite-like carbon is present in biochar produced via hydrothermal liquefaction of C. merolae algae biomass. The temperature range used during this liquefaction process is about 300° C. to about 350° C., suggesting the presence of disordered polyaromatic clusters in the biochar structure.

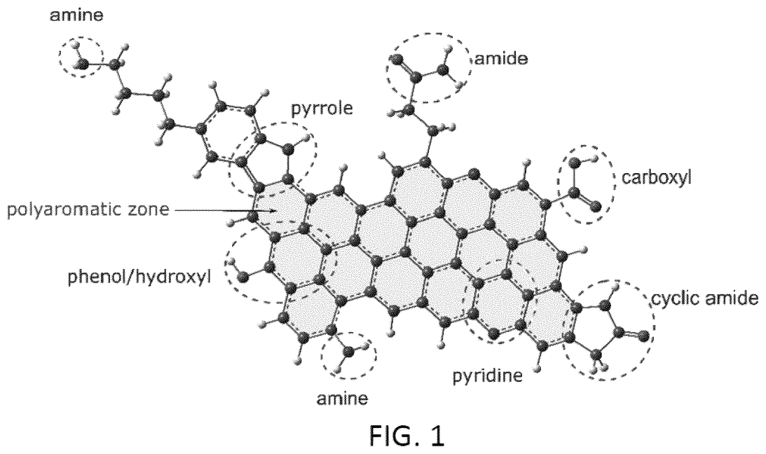

The types of chemical bonds and atomic ratios extracted from Fourier-transform infrared spectroscopy are utilized for the model. The high protein content in algal feedstock increases nitrogen concentration, which encourages N-functional group formation in the biochar. The presence of carbohydrates in the microalgae composition can enhance nitrogen retention in biochar during thermochemical conversion of the biomass. Oxygen functional groups such as carbonyl, ketene, phenol, and carboxyl, as well as nitrogen functional groups, are present on the surface of algae biochar. An N—H stretching peak is detected in the range of 1600 to 1670 cm⁻¹. Additionally, minor peaks between 2100 cm⁻¹ and 2270 cm⁻¹ in pure algae and mixed samples can be attributed to amides and ketones. FIG. 1 depicts a molecular model of the algae-based biochar used herein and identifies all N-functional groups. The functional groups adorning the central polyaromatic region impact the adsorption capacity of the biochar. The integration of these functional groups into the model facilitates an understanding of the mechanisms of heavy-metal adsorption and their influence on the selective adsorption process.

The hydrothermal liquefaction of algae feedstock in the production of biochar yields a matrix rich in base cations such as potassium, calcium, magnesium, and sodium. The composition of these cations plays a role in metal adsorption, primarily through an ion-exchange mechanism. Energy results from density functional theory calculations supports the competitive adsorption of these heavy metals, with a decreasing competitiveness order of Cu²⁺>Fe²⁺>Zn²⁺ as they displace inherent cations such as K⁺.

Examination of cation-π interactions between the heavy-metal ions (e.g., Zn²⁺, Cu²⁺, and Fe²⁺) and the polyaromatic core of algae biochar provides insight into the underlying mechanisms of heavy-metal sequestration. The Cu²⁺ ions exhibit the strongest affinity; their strong interaction with the biochar's aromatic system is due at least in part to the Cu²⁺ ion's [Ar] 3d⁹ electronic configuration. This promotes effective x-backbonding at least in part because of the electrons in the Cu²⁺ ion's valence orbitals and a favorable size compatibility with the π electron cloud of the biochar's aromatic core. The Zn²⁺ ions display a relatively weaker interaction. This can be attributed to its fully filled [Ar] 3d¹⁰ configuration, which limits its ability to form robust π-complexes.

Molecular modeling further shows the distinctive positional preferences of metal ions on the polyaromatic system. While the Fe²⁺ ions and the Zn²⁺ ions predominantly favor the central position above a single benzene ring, the Cu²⁺ ions shows an affinity for the junction point of three benzene rings. This can be attributed to the capability of the Cu²⁺ ion for multicenter cation-π interactions.

Nitrogen-containing functional groups, such as amines, amides, and pyridines, exhibit strong tendencies to facilitate ion-exchange mechanisms with the heavy-metal ions (e.g., Zn²⁺, Cu²⁺, and Fe²⁺). The affinity of nitrogen-containing functional groups for the metal ions was stronger than the affinity of oxygen-containing functional groups for those metal ions. Despite these different operations, the co-presence of both oxygen-containing functional groups and nitrogen-containing functional groups in biochar can lead to a synergistic effect, thereby enhancing the overall capacity for heavy-metal adsorption.

Ultraviolet-visible spectroscopic analysis reveals that algae biochar exhibits selective adsorption capabilities, as evidenced by distinct changes in absorption profiles after treatment with FeCl₂ and CuCl₂. These changes, including new shoulder peaks at 256 nm and 325 nm for the FeCl₂ treatment and a shoulder peak at 255 nm for the CuCl₂ treatment, suggest specific interactions such as potential cation-π interactions, exchange interactions, or other metal-binding mechanisms. Conversely, the minimal spectral response to the ZnCl₂ treatment highlights the biochar's potential for targeted sequestration of specific metal ions.

Thermogravimetric analysis demonstrates that the thermal degradation profile of algae biochar changes in the presence of metal salts, indicating that metal ions interact with the biochar. The absence of characteristic endothermic peaks in metal-treated biochar, compared to the pristine biochar, suggests the formation of complexes between metal ions and biochar's functional groups, supported by altered thermal events and heat flow measurements.

Thermogravimetric analysis indicates selective adsorption properties of algae biochar for different metal ions, as evidenced by the distinct thermal degradation patterns when treated with FeCl₂, CuCl₂, and ZnCl₂. The FeCl₂-treated biochar exhibited a 6.6% mass loss from 170° C. to 200° C., whereas the CuCl₂ and ZnCl₂ treatments led to a 46% and 37% mass loss at broader temperature ranges, respectively. These findings suggest that algae biochar has different immobilization of metal leachate from mine tailings, thereby facilitating the safe use of mine tailings in construction applications.

### COMPUTATIONAL AND EXPERIMENTAL DETAILS

Plastic fibers were made from waste plastics (e.g., polyethylene terephthalate or polyethylene terephthalate glycol). The resulting plastic fibers were treated with bio-oil (e.g., in a weight ratio of about 1:1), and the mixture was left at ambient temperature for 12 hours. The mixture was irradiated with microwave irradiation at 400 watts for 5 minutes. The mixture was taken out to be stirred for 10 minutes using a stainless-steel lab spoon. The mixture was irradiated again, stirred for 10 minutes, and washed with acetone to remove the excess bio-oil for 5 minutes. The mixture was dried at a temperature of 60° C. to yield bio-treated plastic fibers. Biochar was soaked in a beaker in a solution of 60 wt % acetone and 40 wt % distilled water. The biochar mixture was stirred using a stainless steel spatula for 10 minutes, then sonicated using a Branson CPX2800H Ultrasonic Digital Bench Top Cleaner with Timer and Heater at 50° C. for 15 minutes. After sonication, the bio-treated plastic fibers were combined with the biochar (e.g., in a weight ratio of about 2:1) mixture to yield a hybrid mixture, and the hybrid mixture was stirred for 10 minutes. The hybrid mixture was then left at ambient temperature for 24 hours, followed by another sonication procedure for 90 minutes. The hybrid mixture was then dried at a temperature of 100° C. for 1 hour, resulting in biochar-coated plastics.

Selective adsorption of heavy metals onto algae biochar was assessed. The computational modeling compared how copper, iron, and zinc interact with the biochar surface. This provided an understanding of the adsorption capabilities of the biochar as well as which metals are preferentially adsorbed in the presence of a mixture of these metals. The DMol3 module of the Accelrys Materials Studio program package was used to optimize the structure of algae biochar and the complexes formed upon adsorption of heavy metals. To identify the biochar's active sites that facilitate metal adsorption and to evaluate the thermodynamic stability of the resulting complexes of biochar and heavy metal, both long-range van der Waals and electrostatic interactions were considered. This included incorporating Grimme's long-range dispersion correction into the PBE (Perdew-Burke-Ernzerhof) functional of the generalized gradient approximation (GGA), or PBE-D. In the optimization process, all-electron double-numerical basis sets were used, inclusive of polarization functions (e.g., dynamic nuclear polarization (DNP)). The calculations were conducted at the “Fine” level of numerical integration with tolerances for energy, maximum force, and displacement convergence set at 1.0×10⁻⁵ Hartree, 2.0×10⁻³ Hartree/Å, and 5.0×10⁻³ Å, respectively.

Multiple candidate mechanisms for metal adsorption over biochar were considered. The thermodynamic stability of the biochar-heavy metal adsorption complexes was determined by calculating the adsorption or binding energy (E_{ads}), defined as the difference between the energy of the adsorbed state and the sum of the energies of the components in their isolated states. In a two-component system of a heavy-metal ion and biochar, the adsorption energy is shown in Equation 1.

$${E}_{ads} = {E}_{adsorbed} - ( {E}_{metal} + {E}_{biochar} ) \qquad ( 1 )$$

In this equation, E_{adsorbed} represents the total energy of the system when the components are in the adsorbed or bound state, while Eₘₑₜₐₗ and E_{biochar} denote the energies of metal ion and biochar, respectively, when they are isolated and at thermodynamic equilibrium. If the adsorption energy of a bound system yields a negative value, it signifies a positive energy shift in the adsorbed state compared to the isolated state. A negative value of the adsorption of a bound system indicated that adsorption is thermodynamically viable. Stronger adsorption was indicated by a more negative value of adsorption energy.

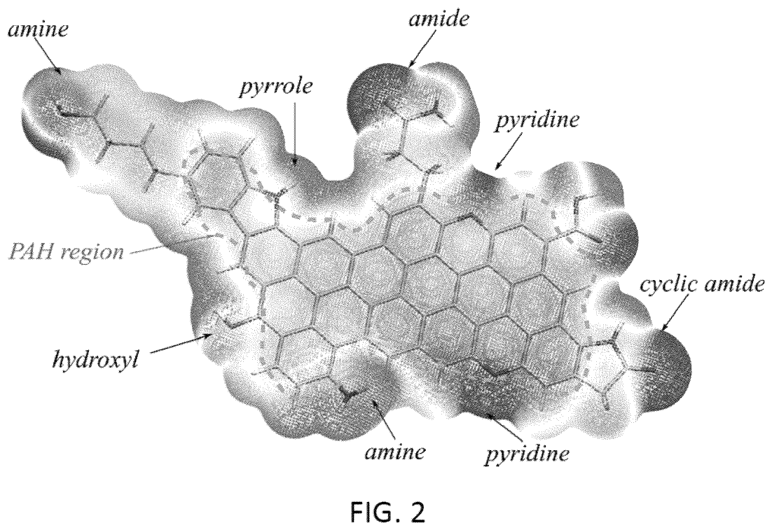

To assess the interactive characteristics of the algae biochar and its affinity toward metal ions, density functional theory calculations were used to visualize the electrostatic potential on the van der Waals surface of biochar. The electrostatic potential was a useful parameter at least in part because it provided insight into how a molecule will interact with its environment, particularly in the context of ion binding sites. Electrostatic potential maps showed regions of positive electrostatic potential and regions of negative electrostatic potential, serving as a guide to probable locations for cation and anion binding, respectively. Utilizing the optimized biochar molecular structure, wave-function files were generated at the PBE/6-31G* level of theory using the Gaussian 16 program package. These files were then inputted into Multiwfn to compute electrostatic potential values. The electrostatic potential surfaces were visualized using the Visual Molecular Dynamics tool, as shown in FIG. 2.

An observation from the electrostatic potential maps was the molecular polarity in the algae biochar. This polarity can be attributed to the presence of nitrogen-carrying functional groups. This enhanced polarity promoted non-covalent interactions with metal ions, emphasizing the role of nitrogen functional groups in immobilizing metals and preventing their leaching in biochar-modified copper mine tailing-based geopolymer. In the electrostatic potential maps, the red regions showed the highest values of electrostatic potential energy, indicating the electron-deficient parts of a molecule. Conversely, the blue regions represented areas with lower electrostatic potential values, indicating a relative abundance of electrons in those regions. The electrostatic potential map was a visual endorsement of the molecular model, illustrating the influence of nitrogen and oxygen functional groups on the overall charge distribution of the biochar molecule. Donor atoms (e.g., oxygen, nitrogen, or other electronegative atoms) located in the blue areas were likely to attract electron-deficient compounds, such as positively charged metal ions. This electrostatic potential visualization supported the molecular model and indicated specific regions of the biochar that are conducive to adsorption of metal ions. The biochar's capacity to sequester metal ions aided in optimizing the adsorption process, allowing anticipation of the binding sites and establishing the initial configuration of the adsorption complex.

Unless specified otherwise, all reagents were acquired commercially at reagent grade and were used as received without additional purification. Reagents and solvents were sourced from Sigma-Aldrich, Fisher Scientific, and VWR International. HPLC-grade acetonitrile was obtained from Fisher Scientific, and metal salts were exclusively procured from Sigma-Aldrich.

Ultraviolet-visible absorbance spectra were collected using a Shimadzu UV-Vis-NIR 3600 spectrophotometer and a quartz cuvette with a 1 cm path length. Thermogravimetric analysis-differential scanning calorimetry measurements were performed on a Mettler Toledo, following the standard protocols.

A sample of algae biochar was exposed to different metal salts at a moderately high temperature to assess the interactions between the metal ions and the biochar spectrophotometrically. 5 mg of algae biochar was weighed into each of three separate 1-dram glass vials (VWR glass vials, 470151-622). 10 mM stock solutions of FeCl₂, CuCl₂, and ZnCl₂ were prepared in a 15 mL scintillation vial using a dichloromethane: ethanol (e.g., 8:2 v/v) mixture. 1 mL of each metal stock solution was then added to the 1-dram glass vials containing the biochar sample. After placing a PTFE-coated stir bar (VWR spinbar micro, 3×10 mm, 58948-375) in each vial, the 1-dram glass vials were tightly capped and sealed with parafilm. The vials were stirred at 50° C. for 48 hours. Subsequent to the incubation period, the samples were analyzed using ultraviolet-visible absorbance spectrophotometry.

For the absorption studies using ultraviolet-visible spectroscopy, samples were diluted with HPLC-grade acetonitrile and analyzed over a wavelength range of 200 nm to 800 nm. Control measurements were conducted on the untreated biochar and the individual metal salts to establish their respective absorption profiles for comparison with the treated biochar samples. For each spectroscopic analysis, 5 μL of the metal salt solution was introduced into a quartz cuvette containing 2 mL of acetonitrile, and the ultraviolet-visible spectra were recorded. Similarly, 5 mg of algae biochar was dissolved in 1 mL of a dichloromethane: ethanol (e.g., 8:2 v/v) mixture, and 5 μL of this biochar solution was then diluted with 2 mL of acetonitrile for control analysis. The treated biochar samples were prepared by adding 5 μL of the sample into a quartz cuvette followed by 2 mL of acetonitrile. The absorption spectra of all samples were observed across the 200 nm to 800 nm wavelength range.

For evaluating the thermal stability, 25 mg to 40 mg of finely ground dry material was weighed into a 70 μL alumina (Al₂O₃) pan with an aluminum lid. The autosampler removed the lid when the sample was placed on the balance to maintain accurate sample mass and to reduce sample deliquescence while waiting for analysis. The lid also allowed for a consistent mass when the samples were in the autosampler tray. A reference measurement was taken with an empty alumina pan. Under a nitrogen flow of 50 mL per minute, samples were heated from 25° C. to 1000° C. at a ramp rate of 10° C. per minute. The thermal stability of the biochar, both in the absence and presence of metal salts, was characterized using thermogravimetric analysis and differential thermal gravimetry parameters. The peak temperatures indicated the degradation of labile and non-labile components. Differential scanning calorimetry parameters provided stability insights through peak temperatures, peak heights (expressed in mW or W/g), and the total heat of the reaction (ΔH) in J/g.

The ability of biochar to adsorb heavy metals was influenced by several factors: the biochar surface area and porosity; the nature and quantity of surface functional groups; and the presence and cation exchange capacity of surface ions. Thus, the prevailing mechanism of metal adsorption by biochar depended on a combination of these aspects. For further theoretical understanding, the mechanism of heavy-metal adsorption on biochar was assessed. The trapping of metal ions by biochar is understood to involve both physical and chemical interactions. The possible chemical adsorption mechanisms driving this process incorporated complexation, ion exchange, and precipitation along with physical and electrostatic adsorption. The sequestration of heavy metals by biochar did not hinge on a singular mechanism. Instead, it occurred through the complex interplay of several mechanisms.

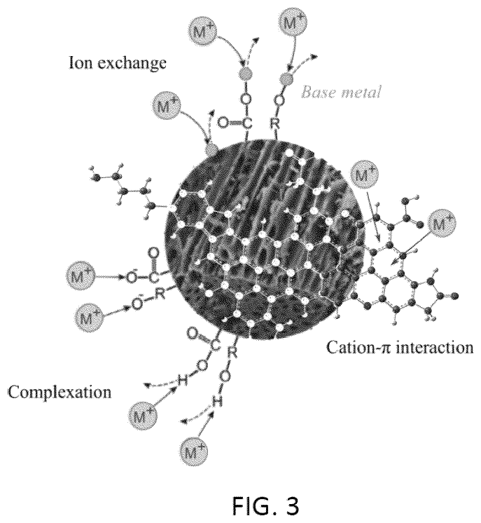

Functional groups present on the surface of biochar acted as active sites for metal ions (e.g., Fe²⁺, Cu²⁺, and Zn²⁺ ions), enabling a variety of adsorption mechanisms. In the complexation process, the metal ions formed coordinate bonds with the oxygen atoms in these functional groups by replacing a proton (H⁺) from the functional group, thereby forming a metal carboxylate or a metal hydroxide and releasing a proton. Another mechanism, ion exchange, was where the inherent metal ions (e.g., K⁺, Na⁺, Ca²⁺, and Mg²⁺ ions) present in biochar could be replaced by other metal ions at least in part because of displacement reactions. Electrostatic attraction also played a role, wherein the negatively charged carboxylate ions formed after the deprotonation interacted with the positively charged metal ions. This interaction was also termed ion-dipole interaction. Physical adsorption, a well-known mechanism for trapping metal ions, occurs in two ways: van der Waals forces between metal ions and polar functional groups; and cation-π interactions with π-donor polyaromatic parts in the molecular structure of biochar. These various adsorption mechanisms are depicted schematically in FIG. 3. The presence and concentration of functional groups on the biochar's surface influenced its capability to effectively and selectively adsorb metal ions. However, the overall process was also dependent on the environmental pH, which affects the protonation state of these functional groups.

Density functional theory calculations were performed to examine the selective adsorption of Fe²⁺, Cu²⁺, and Zn²⁺ ions on algae biochar. Computational models were constructed for the algae biochar and the respective metal ions, with the biochar model focusing on representative functional groups that were thought to be most responsible for adsorption, as shown in FIG. 1. Following this, geometry optimizations were conducted for each metal-biochar system, allowing identification of the most stable configuration for each system. This step allowed for accurate predictions of adsorption energies. Subsequently, the adsorption energy was computed as the difference between the energy of the optimized metal-biochar system and the sum of the energies of the isolated biochar and metal ion, as detailed in Equation 1. With these models, the mechanisms of adsorption were assessed, analyzing the electronic structure around the adsorption site to understand charge redistribution upon adsorption. This approach offered insight into the likely dominant adsorption mechanisms, such as electrostatic attraction, complexation, or ion exchange. Finally, to determine selective adsorption, the adsorption energies of different metal ions were compared. The ion with the most negative adsorption energy was considered as the preferred ion for adsorption by the biochar.

Considering the complexities of modeling the adsorption processes in the biochar in a real-world geopolymer matrix, the density functional theory calculations were performed in the gas phase for simplicity and to focus on the primary interactions between the ions and the biochar. Therefore, the high adsorption energies obtained may not directly correspond to the energies one might observe in a more complex, solid-phase system at least in part because of the absence of factors such as solvent effects and competitive adsorption from other species. However, these calculations still provided valuable insight into the relative strength of interaction between the different metal ions and the biochar and helped to elucidate the possible mechanisms for the adsorption of the metal ions. Thus, despite the high adsorption energies obtained, the results were still a reliable indicator of the selectivity of the biochar for different metal ions and the potential for ion exchange as an adsorption mechanism. Understanding the selectivity order can facilitate selection and application of biochar for heavy-metal remediation.

During the pyrolysis process, organic matter in the feedstock was carbonized, and inorganic components were converted into ash. This ash is rich in minerals, including base cations such as potassium, calcium, magnesium, and sodium. The concentration and type of these cations depended on the nature of the feedstock material used, especially its mineral content. For instance, feedstocks with a high mineral content, such as certain types of manure or plant-based matter, can yield biochar with higher levels of base cations. Algae, known for their ability to naturally accumulate minerals from their environment, can serve as an effective biochar feedstock. During pyrolysis, the minerals in algae were left behind in the biochar in the form of ash, which included base cations. However, the composition of these cations in the resulting biochar depended on the specifics of the algal feedstock and the parameters of the pyrolysis process, such as temperature and duration.

The presence of base cations played a role in the adsorption and immobilization of heavy metals in biochar. This occurred primarily through an ion-exchange mechanism, where the base cations originally present in the biochar structure were replaced by heavy-metal cations from the environment. The biochar acted like a sponge, absorbing the heavy-metal cations while simultaneously releasing the biochar's base cations. Moreover, base cations can influence the surface charge of the biochar. Typically, biochar carries a negative charge at least in part because of the deprotonation of surface functional groups. These base cations can neutralize the surface charge, consequently increasing the pH of the point of zero charge (pH_{pzc}) and thereby expanding the range of pH values at which the biochar can adsorb positively charged heavy-metal ions. This process can serve as a dominant pathway for heavy-metal adsorption in biochar.

Base cations, including potassium, can be retained in biochar through a combination of electrostatic interactions and complexation with the biochar's functional groups. In algae biochar, both oxygen-containing and nitrogen-containing functional groups are present, serving as potential adsorption sites for metal ions. The role of these functional groups in the ion-exchange process was understood to be one of several mechanisms involved in metal-ion adsorption. Amongst the ions contained in biochar, potassium (K⁺) was considered. A base cation in biochar such as potassium could be replaced by metal ions such as copper (Cu²⁺), zinc (Zn²⁺), and iron (Fe²⁺) via ion exchange. This process involved a displacement reaction, where the less strongly adsorbed ions (K⁺) were substituted by the more strongly adsorbed metal ions (e.g., Cu²⁺, Zn²⁺, and Fe²⁺ ions).

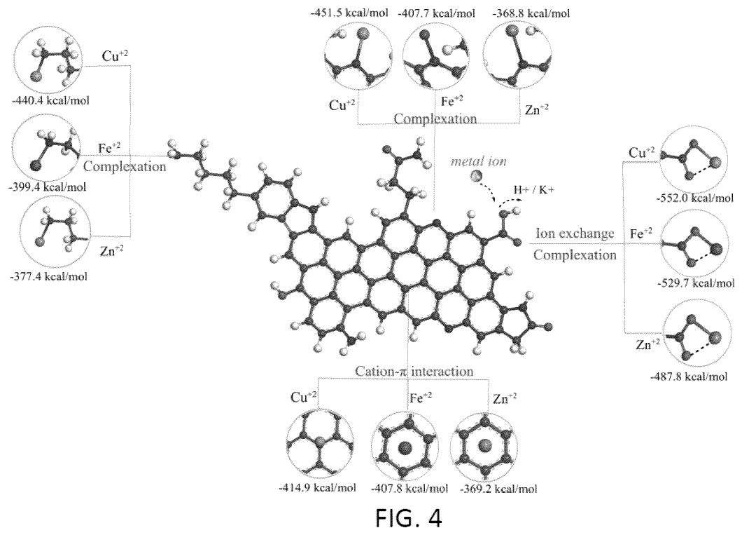

Gas-phase density functional theory calculations were used to assess the feasibility of ion exchange as a mechanism for the adsorption of heavy-metal ions (e.g., Cu²⁺, Zn²⁺, and Fe²⁺ ions) onto algae biochar. The interaction energy of a biochar-bound potassium ion was compared with that of biochar-bound heavy-metal ions. A more negative interaction energy for the heavy-metal ions could indicate stronger binding to the biochar, suggesting a potential preference for ion exchange. Referring to FIG. 4, calculated energy values show that the adsorption energy between Cu²⁺, Fe²⁺, and Zn²⁺ ions and the biochar was more negative than the energy released by the adsorption of K⁺ to the same adsorption site (e.g., —COO⁻) on the biochar, with values of −552.0 kcal/mol, −529.69 kcal/mol, and −487.8 kcal/mol compared to −121.8 kcal/mol, respectively. Furthermore, a comparison of the adsorption energy for the different heavy metals suggested a selectivity order of Cu²⁺>Fe²⁺>Zn²⁺ for biochar adsorption. Thus, there was a competitive adsorption of these heavy metals with the above-mentioned decreasing order of competitiveness.

Nitrogen-containing functional groups such as amines, amides, and pyridines can contribute to the ion-exchange mechanism in algae biochar. These groups are inherently basic due at least in part to the presence of a lone pair of electrons on the nitrogen atom and can act as active sites for the adsorption of heavy-metal ions. In this process, the adsorption is facilitated by the replacement of inherent cations such as K⁺ ion, Na⁺ ion, Ca²⁺ ion, or even protons attached to these functional groups. In the context of this example, biochar acts as a host matrix, facilitating the exchange of its inherent cations with heavy-metal ions present in the geopolymer matrix. This ion-exchange mechanism resulted in the displacement of the inherent cations of biochar, effectively creating vacant sites that are occupied by heavy-metal ions.

The role of nitrogen-containing functional groups (e.g., pyridine, amine, and amide) in facilitating the ion-exchange mechanism was assessed. Density functional theory calculations were carried out to compare the adsorption of inherent potassium ions and each of the investigated heavy metals on these nitrogen-containing groups in the algae biochar. Referring to FIG. 4, the heavy-metal ions (e.g., Cu²⁺, Zn²⁺, and Fe²⁺ ions) displayed a stronger interaction with all the investigated nitrogen-containing groups compared to the inherent K⁺ ions. This was indicated by the more negative values of adsorption energy obtained for the heavy metals compared to the K⁺ ions. For example, in the case of pyridine, heavy-metal ions (e.g., Cu²⁺, Zn²⁺, and Fe²⁺ ions) displayed a stronger interaction with the pyridine group compared to the inherent K⁺ ions, as indicated by the more negative adsorption energy values. The calculated adsorption energy values were −451.5 kcal/mol for the Cu²⁺ ion, −368.8 kcal/mol for the Zn²⁺ ion, −407.7 kcal/mol for the Fe²⁺ ion, and −121.8 kcal/mol for the K⁺ ion. These results suggested that these heavy metals can displace K⁺ ions at the nitrogen sites not only in pyridine groups, but also in ca functional groups. This indicated the likely involvement of diverse nitrogen-containing functional groups in the ion-exchange process and highlighted their collective potential to enhance heavy-metal adsorption in algae biochar.

In addition to the ion-exchange mechanism, density functional theory calculations provided insights into the potential for complexation between the functional groups on algae biochar and heavy-metal ions. Complexation involved the formation of a stable bond between a heavy-metal ion and a functional group, creating a complex that remains attached to the biochar. In comparing the complexation mechanisms of oxygen-containing functional groups and nitrogen-containing functional groups in the adsorption of heavy metals, distinctions emerged. Oxygen-containing functional groups such as carboxylic and hydroxyl groups present on the biochar surfaces played a role in adsorbing heavy-metal ions. When biochar was subjected to an alkaline environment, such as the one created by the use of sodium hydroxide (NaOH) in the geopolymer production process, these acidic functional groups (e.g., carboxylic group and hydroxyl group) can be deprotonated. This resulted in the functional groups being negatively charged (e.g., —COO⁻ and —O⁻), which facilitated the formation of complexes with positively charged heavy-metal cations in the solution. In contrast to the oxygen-containing functional groups, nitrogen-containing functional groups (e.g., amine, amide, and pyridine) exhibit basic characteristics. Certain oxygen-containing functional groups, such as the carbonyl group, can also exhibit basic characteristics. The functional groups have a high electron density on the heteroatoms, contributed by the lone pairs of electrons. These functional groups were capable of donating their electron lone pairs to form stable complexes with metal ions, a process that facilitated their adsorption and potential sequestration from the solution. The formation of these stable complexes indicated the role of these nitrogen-containing and oxygen-containing groups in adsorbing and immobilizing heavy metals from the solution.

Similar to ion exchange, the density functional theory-based results and molecular modeling shown in FIG. 4 suggested that the nitrogen-containing functional groups could provide a pathway for the adsorption of heavy metals in algae biochar. The interaction energies suggest that nitrogen-containing functional groups displayed a favorable interaction with the heavy metals, at least in part because of the inherent basicity of nitrogen-containing functional groups and their ability to donate electron pairs to form strong, stable complexes. The values for interaction energy obtained from the density functional theory calculations showed that the affinity of the nitrogen-containing functional groups (e.g., pyridine, amine, and amide) for the considered metal ions (e.g., Cu²⁺, Zn²⁺, and Fe²⁺ ions) was stronger than the affinity of the oxygen-containing functional groups for those metal ions, with a selectivity order of Cu²⁺>Fe²⁺>Zn²⁺. This suggested that the nitrogen functionalities in algae biochar can serve as efficient complexation sites, thereby enhancing the overall efficacy of sequestering heavy-metal ions. This highlighted the versatility of algae biochar in adsorbing heavy-metal ions, offering multiple routes (e.g., ion exchange and complexation) for heavy-metal immobilization. The co-presence of both oxygen-containing functional groups and nitrogen-containing functional groups in biochar can promote a synergistic effect, thereby enhancing the overall capacity for heavy-metal adsorption.

A component of the density functional theory calculations on the adsorption of Zn²⁺, Cu²⁺, and Fe²⁺ ions onto algae biochar was their potential interaction through cation-π mechanisms. A defining structural feature of biochar is its polyaromatic segments, and the polyaromatic segments are areas rich in π electrons. The cation-π interactions were a result of electrostatic attraction between the positive charge of the metal cation and the negative potential regions of the biochar's π-system. In aromatic systems, such as the polyaromatic core present in biochar, the π electrons are delocalized and form a cloud of electron density above and below the plane of the molecule. These negatively charged clouds can attract and interact with positively charged metal cations, forming cation-π interactions. Based on the electrostatic potential analysis, the polyaromatic core of the algae biochar model, in addition to the functional groups, possesses regions of low electrostatic potential which indicate a high concentration of electron density. These regions functioned as π-donors, which can have a propensity to attract heavy-metal cations.

The energy results obtained from the density functional theory calculations provided an insight into the strength and nature of the cation-π interactions in the system. For example, the adsorption energy of Zn²⁺ ions onto the polyaromatic segments was found to be −369.2 kcal/mol; the adsorption energy for Cu²⁺ ions was −414.9 kcal/mol, and the adsorption energy for Fe²⁺ ions was −407.8 kcal/mol. These values suggested that these metal ions were being strongly adsorbed onto the biochar via cation-π interactions. The adsorption energy for the Cu²⁺ ion was found to be the most negative among the three metal ions, indicating that Cu²⁺ ions might have the highest affinity for the π-rich regions of the biochar, followed by Fe²⁺ ions and Zn²⁺ ions.

The observed energy trends in the cation-interactions of Cu²⁺, Fe²⁺, and Zn²⁺ with the biochar's π-system could be attributed to their ionic radii, charge densities, and specific electronic configurations. Among the Cu²⁺, Fe²⁺, and Zn²⁺ ions, the Cu²⁺ and Fe²⁺ ions were known to be able to form strong π-complexes at least in part because of their specific electronic configurations. Zn²⁺ ions were typically less capable of forming such complexes at least in part because it has a fully filled [Ar] 3d¹⁰ configuration. In addition, transition metals such as Cu²⁺ and Fe²⁺ ons, which have partially filled d-orbitals, can engage in π-backbonding with the π-system, further strengthening the cation-π interaction. “π-backbonding” describes an interaction where an electron-rich species donates electron density to a metal center, and the metal, in turn, donates electron density back into the π* (anti-bonding) orbitals of the ligand. This is a well-known concept in the context of transition-metal complexes where the central metal atom or ion has d-orbitals that are partially filled or empty. The π electron cloud of the biochar can act as the ligand, donating electron density to the metal ion and accepting electron density back into its π* orbitals. This back-donation can enhance the stability of the cation-π interaction, making it more favorable energetically. Cu²⁺ ions exhibited the highest affinity for the π-system among the three metal ions. This could be due at least in part to a favorable size match between Cu²⁺ ions and the aromatic system and the capability of Cu²⁺ ions to form strong x-backbonding, at least in part because of its electronic configuration. A Cu²⁺ ion has a +2 charge and a [Ar] 3d⁹ configuration, which could enhance its interaction with the π electron cloud despite its smaller size. Furthermore, Cu²⁺ ions can engage in π-backbonding, which involves the donation of electron density from the π cloud of the polyaromatic core to the empty orbitals of the metal ion, thereby strengthening the cation-π interaction. Therefore, these factors, particularly the electronic configuration, likely contributed to the trend in adsorption energy observed for the interaction of these metal ions with the biochar.

The observed positions of the metal ions provided information about the cation-π interactions and could contribute to understanding the selectivity and efficiency of heavy-metal adsorption by biochar. Referring to FIG. 4, the molecular modeling showed that Zn²⁺ and Fe²⁺ ions preferred to interact with the center of a single benzene ring in the polyaromatic system, while the Cu²⁺ ion preferred the junction point of three benzene rings. The central position above a benzene ring was often favorable for cation-π interactions due at least in part to the symmetric arrangement of the π electrons below the metal ion. However, the interaction at the junction of three benzene rings for the Cu²⁺ ion suggested a multicenter interaction, where the Cu²⁺ ion was interacting with the π electrons from multiple rings simultaneously. The electronic structure and size of metal ions can affect their adsorption position over the polycyclic aromatic hydrocarbon. For example, Cu²⁺ ion could be able to form stronger or more stable multicenter interactions at least in part because of its electronic configuration and size.

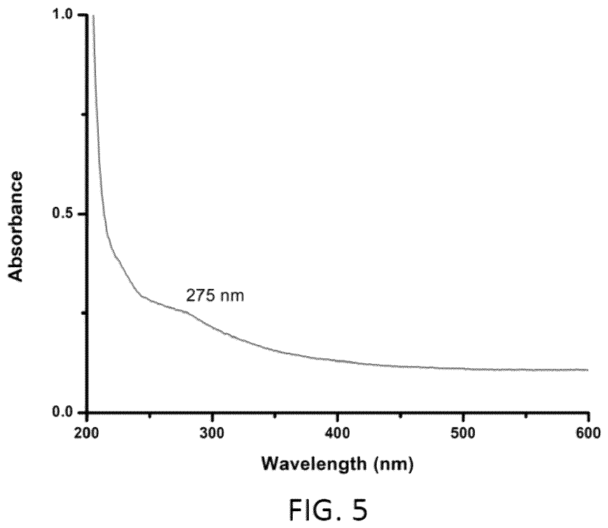

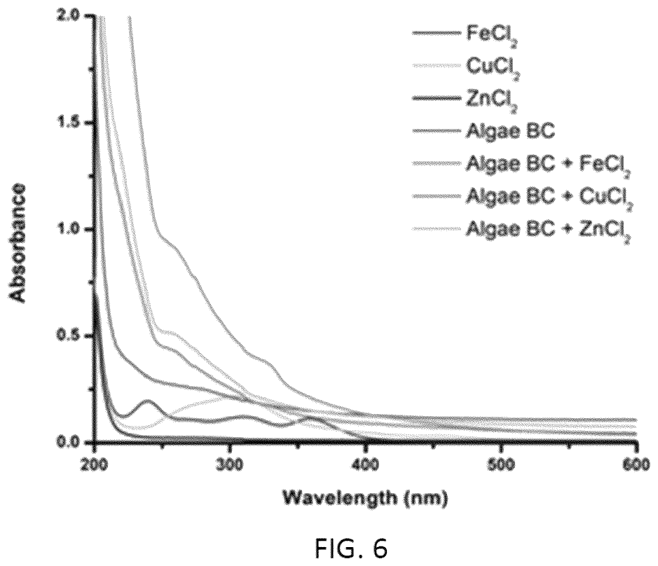

Spectroscopic analyses of untreated algae biochar, metal salts, and treated algae biochar samples were performed across the 200 nm to 800 nm wavelength range. When solubilized in a dichloromethane: ethanol (e.g., 8:2 v/v) mixture, the metal salts exhibited a distinctive absorption maxima (λmax) within the ultraviolet-visible spectrum, as shown in FIG. 5. FeCl₂ demonstrated sharp peaks at 240 nm, 310 nm, and 360 nm, while CuCl₂ showed a broad peak at 305 nm and a medium-intensity peak at 460 nm. In contrast, ZnCl₂ did not exhibit any characteristic peaks in the analyzed region. The algae biochar spectrum was typically broad and lacked distinct features, due at least in part to the overlapping absorption bands from various chromophores. A shoulder at 275 nm, indicative of n-π* and I-π* transitions, was observed in the algae biochar. This shoulder can be attributed to the presence of heteroatom-containing functional groups and a conjugated polyaromatic structure. With the addition of metal salts, the treated algae biochar samples exhibited altered absorption profiles, as shown in FIG. 6. Treatment with FeCl₂ resulted in the emergence of shoulder peaks at 256 nm and 325 nm, whereas with CuCl₂, a medium-intensity shoulder peak appeared at 255 nm. These changes suggested possible interactions between the algae biochar and the Fe²⁺ and Cu²⁺ ions, potentially through cation-π interactions, exchange interactions, or metal-binding mechanisms. The ZnCl₂-treated biochar sample also showed a shoulder peak at 257 nm.

To complement the spectroscopic analysis and elucidate the interactions between metal ions and algae biochar, the biochar's thermal stability, which influences its carbon sequestration capability, was assessed. Thermogravimetric analysis was employed to evaluate the thermal stability of both untreated and metal-treated biochar samples under an inert atmosphere. The thermogravimetric analysis data, indicating the percentage of weight loss, provided insights into the relative stability of the sample. Upon gradual heating at a rate of 10° C. per minute, degradation was observed below 200° C., indicating the presence of a volatile organic carbon. Between 200° C. and 380° C., labile organic components such as cellulose and aliphatic carbons were released. Degradation occurring from 380° C. to 475° C. corresponded to the loss of recalcitrant carbon, which were typically lignin and its derivatives. Refractory organic carbon, including polycondensed lipids and aromatic carbon, decomposed between 475° C. and 600° C. Above 600° C., the loss was attributed to inorganic carbonates. The peak degradation temperature, reaching 1000° C., was observed to be a reliable indicator of thermal stability in an inert atmosphere. The thermogravimetric analysis results revealed that the thermal degradation profiles of the algae biochar samples were altered in the presence of different metal salts.

The thermogravimetric analysis and differential thermal gravimetry curves illustrated the characteristic thermal degradation of the algae biochar sample. Initially, the biochar underwent a 3.5% mass loss at 115° C., attributed at least to the volatilization of organic content. Subsequently, around 20% of the mass was lost at 300° C. due at least in part to the degradation of labile organic components such as cellulose, carbohydrates, and aliphatic carbon. At 460° C., the biochar experienced an additional 36% loss of its initial mass from the decomposition of recalcitrant organic carbon, mainly lignin. Beyond this temperature, the biochar remains stable up to 1000° C., with approximately 40% residue left. The heat flow associated with the degradation process indicated an exothermic reaction. This was supported by the differential scanning calorimetry measurements, which showed an exothermic peak persisting until 1000° C.

When the algae biochar was treated with FeCl₂, a mass loss of approximately 6.6% was observed between 170° C. and 200° C., and the evolution of recalcitrant organic carbon occurred at 450° C. FeCl₂ alone exhibited a 26% mass loss at temperatures of 150° C. and 220° C., and underwent degradation with the remainder of the mass lost between 750° C. and 850° C. The negligible release of volatile organic carbons at temperatures below 150° C. and above 500° C. in the FeCl₂-treated algae biochar suggested an interaction of functional groups on the biochar surface with Fe²⁺ ions. This is supported at least by the discrepancy between the degradation phases of the treated biochar and the FeCl₂ control.

In the presence of CuCl₂, the degradation of algae biochar occurred evenly between 125° C. and 460° C., resulting in a 46% loss of both volatile organic and recalcitrant organic carbon content. CuCl₂ alone exhibited a 25% mass loss at 505° C. and continued to degrade gradually beyond 580° C. until 860° C. When compared to the metal control, the differential thermal gravimetry curves of algae biochar with CuCl₂ suggested that Cu²⁺ ions could have formed complexes with various functional groups on the biochar, potentially creating high molecular weight compounds. Moreover, when treated with ZnCl₂, the algae biochar showed a 37% loss of its volatile and recalcitrant content between 150° C. and 450° C., and an additional 18% loss of refractory organic and aromatic carbon from 550° C. to 700° C. Given that ZnCl₂ primarily degrades between 600° C. and 660° C., this suggested that the interactions between Zn²⁺ ions and the biochar could be weaker in comparison.

The heat flow analysis of algae biochar treated with metal salts revealed the absence of characteristic endothermic peaks, which were otherwise observed at specific temperatures for FeCl₂, CuCl₂, and ZnCl₂, suggesting an interaction between the metals and the biochar. For example, untreated FeCl₂ showed three endothermic peaks at 148° C. (ΔH=−236.35 J/g), 217° C. (ΔH=−419.50 J/g), and 684.6° C. (ΔH=−199.65 J/g). Similarly, CuCl₂ exhibited two peaks at 86.78° C. (ΔH=−23.64 J/g) and 497.74° C. (ΔH=−483.01 J/g). ZnCl₂ showed three peaks at 233.53° C. (ΔH=−56.71 J/g), 281.49° C. (ΔH=−32.37 J/g), and 645.95° C. (ΔH=−296.75 J/g). The endothermic peaks for FeCl₂ and CuCl₂ treated biochar were absent, indicating an alteration due at least in part to the interaction. In contrast, the ZnCl₂ treated biochar exhibited new endothermic peaks at 466.21° C. (ΔH=−85.51 J/g) and 820.69° C. (ΔH=−821.74 J/g), which were not present in the untreated biochar. The presence of these thermal events, along with an exothermic drift, suggested the presence of electrostatic or metal exchange interactions between the metal ions and the biochar's surface functional groups.

Although this disclosure contains many specific embodiment details, these should not be construed as limitations on the scope of the subject matter or on the scope of what may be claimed, but rather as descriptions of features that may be specific to particular embodiments. Certain features that are described in this disclosure in the context of separate embodiments can also be implemented, in combination, in a single embodiment. Conversely, various features that are described in the context of a single embodiment can also be implemented in multiple embodiments, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular embodiments of the subject matter have been described. Other embodiments, alterations, and permutations of the described embodiments are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results.

Accordingly, the previously described example embodiments do not define or constrain this disclosure. Other changes, substitutions, and alterations are also possible without departing from the spirit and scope of this disclosure.

What is claimed is:

1. A building material comprising:
bio-oil treated plastic; and
biochar adhered to an exterior surface of the bio-oil treated plastic.

2. The building material of claim 1, wherein the bio-oil treated plastic comprises waste plastic.

3. The building material of claim 2, wherein the waste plastic comprises polyethylene terephthalate, polyethylene terephthalate glycol, or a combination thereof.

4. The building material of claim 1, wherein the bio-oil treated plastic comprises plastic granules or plastic fibers.

5. The building material of claim 1, wherein the biochar comprises algae biochar.

6. The building material of claim 1, wherein the biochar has a selectivity order of Cu²⁺>Fe²⁺>Zn²⁺ for biochar adsorption.

7. The building material of claim 1, wherein K⁺ ions of the biochar are displaced from a nitrogen site of amines, amides, or any combination thereof.

8. The building material of claim 1, wherein an affinity of heavy metal ions in the biochar is greater for nitrogen-containing functional groups than oxygen-containing groups.

9. The building material of claim 8, wherein the heavy metal ions comprise Cu²⁺, Fe²⁺, Zn²⁺, or any combination thereof.

10. The building material of claim 1, further comprising aggregate.

11. The building material of claim 1, further comprising mine tailings.

12. The building material of claim 11, wherein the mine tailings comprise copper mine tailings.

13. A geopolymer material comprising the building material of claim 1.

14. A cement comprising the building material of claim 1.

15. An asphalt comprising the building material of claim 1.

16. The asphalt of claim 15, wherein the asphalt is an open-graded friction course asphalt.

17. A method of capturing metals from mine tailings, the method comprising:
combining the building material of claim 1, mine tailings, and an alkaline activator to yield a mixture; and
polymerizing the mixture to yield a geopolymer.

18. The method of claim 17, wherein the mine tailings comprise copper mine tailings.

19. The method of claim 17, wherein the alkaline activator comprises sodium hydroxide.

20. The method of claim 17, wherein an alkaline environment created by the alkaline activator deprotonates acidic functional groups.
